(19) United States
(12) Patent Application Publication
(10) Pub. No.: US 2026/0233918 A1
(43) Pub. Date: Aug. 13, 2026

(54) CLIMATE-CONTROLLED PRODUCE CONTAINER

(71) Applicant: James Floro, Alliston (CA)

(72) Inventor: James Floro, Alliston (CA)

(21) Appl. No.: 19/051,967

(22) Filed: Feb. 12, 2025

(51) Int. Cl. B65D 81/20; B65D 43/20; B65D 85/34

(52) U.S. Cl. CPC B65D 81/2076; B65D 43/20; B65D 85/34

(57) ABSTRACT

A climate-controlled produce container includes a housing and a cover to open and close the storage space. The housing includes an interior vent and an exterior vent in fluid connection with a vacuum pump. The vacuum pump is selectively actuatable to pump gas from the storage space through the interior vent and out through the exterior vent. A first gas tank contains compressed nitrogen, and a second gas tank contains compressed carbon dioxide. A flow regulator is connected to each of the first gas tank and the second gas tank to selectively control flow of nitrogen gas and carbon dioxide gas into the storage space. A microprocessor is connected to the vacuum pump, the flow regulator, and a sensor to control operation thereof to selectively adjust the concentration of oxygen, nitrogen, and carbon dioxide in the storage space to minimize decay of fresh produce in the storage space.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to produce containers and more particularly pertains to a new climate-controlled produce container for keeping produce fresh. As is well known, fresh produce ripens and decays due to different factors, one of which is the concentration of different gases, such as oxygen, nitrogen, and carbon dioxide, in the surrounding environment. The new container utilizes a vacuum pump, a flow regulator, and a sensor to selectively adjust the concentration of oxygen, nitrogen, and carbon dioxide in a storage space to minimize decay of fresh produce in the storage space.

### (2) Description of Related Art Including Information Disclosed Under 37 CFR 1.97 and 1.98

The prior art relates to produce containers and ways of controlling the gas concentration in such containers. The prior art, as best understood, does not disclose climate-controlled produce container that includes a two gas tanks, wherein one contains compressed nitrogen and the other contains compressed carbon dioxide. In one possible embodiment, the produce container is designed to be placed on a countertop, rather than being installed in a refrigerator or similar appliance.

### (H) BRIEF SUMMARY OF THE INVENTION

An embodiment of the disclosure meets the needs presented above in a climate-controlled produce container generally comprising a housing and a cover. The housing defines a storage space and includes an aperture to access the storage space. The cover is coupled to the housing over the aperture. The cover is selectively movable to open and close the storage space. A vacuum pump is attached to the housing. The housing includes an interior vent and an exterior vent in fluid connection with the vacuum pump. The vacuum pump is selectively actuatable to pump gas from the storage space through the interior vent and out through the exterior vent. A first gas tank is attached to the housing. The first tank contains compressed nitrogen. A second gas tank is attached to the housing. The second gas tank contains compressed carbon dioxide. A flow regulator is attached to the housing. The flow regulator is connected to each of the first gas tank and the second gas tank to selectively control flow of nitrogen gas and carbon dioxide gas into the storage space. A sensor is attached to the housing. The sensor is designed to detect concentration of oxygen, nitrogen, and carbon dioxide in the storage space. A microprocessor is attached to the housing. The microprocessor is connected to the vacuum pump, the flow regulator, and the sensor. The microprocessor is designed to control operation of the vacuum pump, the flow regulator, and the sensor to selectively adjust the concentration of oxygen, nitrogen, and carbon dioxide in the storage space to minimize decay of fresh produce in the storage space. A power supply is attached to the housing. The power supply is connected to the microprocessor, the vacuum pump, the flow regulator, and the sensor.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a climate-controlled produce container according to an embodiment of the disclosure.

FIG. 2 is a front top view of an embodiment of the disclosure.

FIG. 3 is a rear bottom view of an embodiment of the disclosure.

FIG. 4 is a side view of an embodiment of the disclosure.

FIG. 5 is a cross-sectional view of an embodiment of the disclosure.

FIG. 6 is a perspective view of an embodiment of the disclosure in use.

FIG. 7 is a perspective view of an alternative embodiment of the disclosure.

FIG. 8 is a top front view of the alternative embodiment of the disclosure.

FIG. 9 is a front view of the alternative embodiment of the disclosure.

FIG. 10 is a cross-sectional view of the alternative embodiment of the disclosure in FIG. 9.

FIG. 11 is a side view of the alternative embodiment of the disclosure in use.

### (J) DETAILED DESCRIPTION OF THE INVENTION

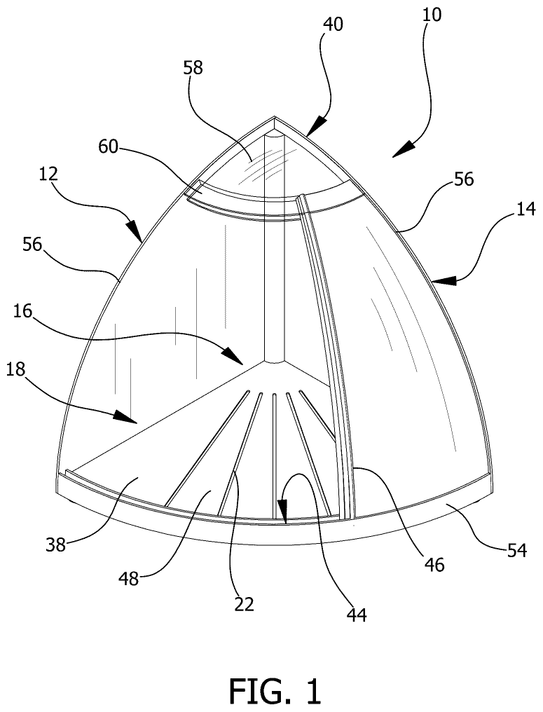

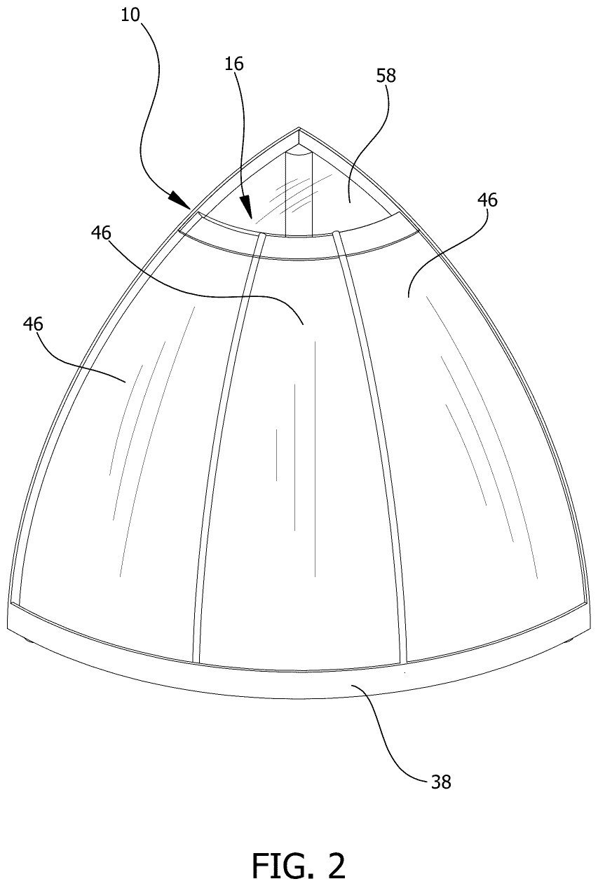

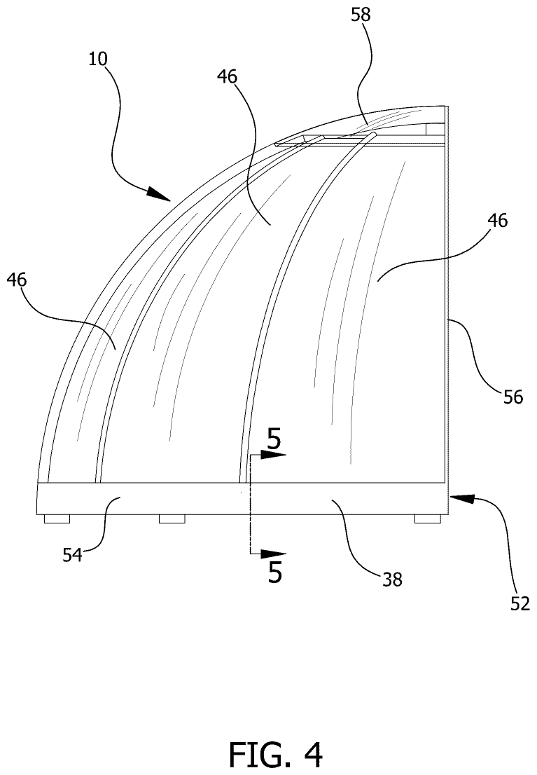

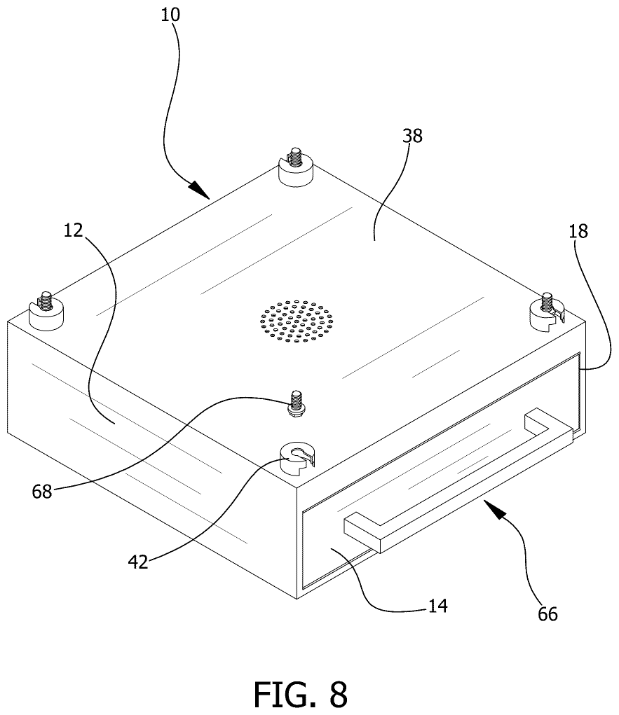

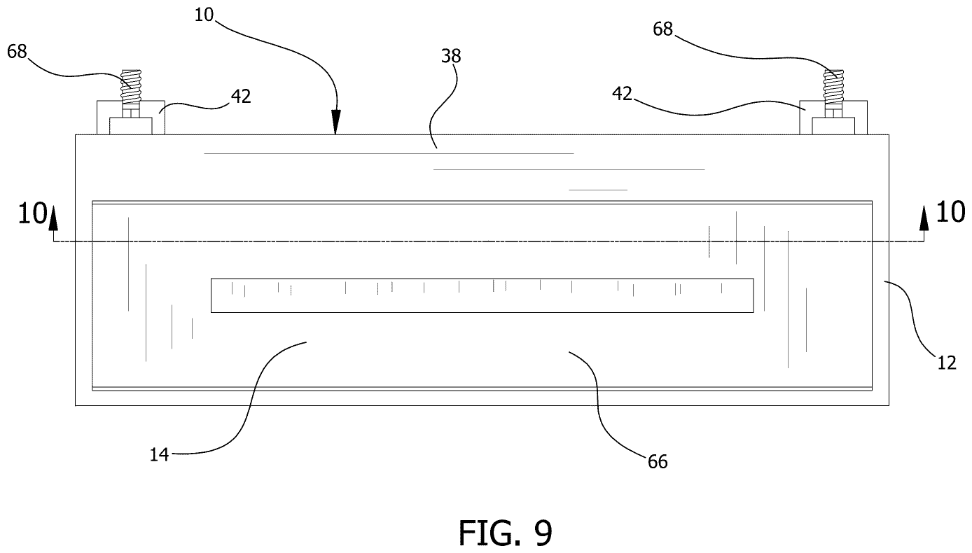

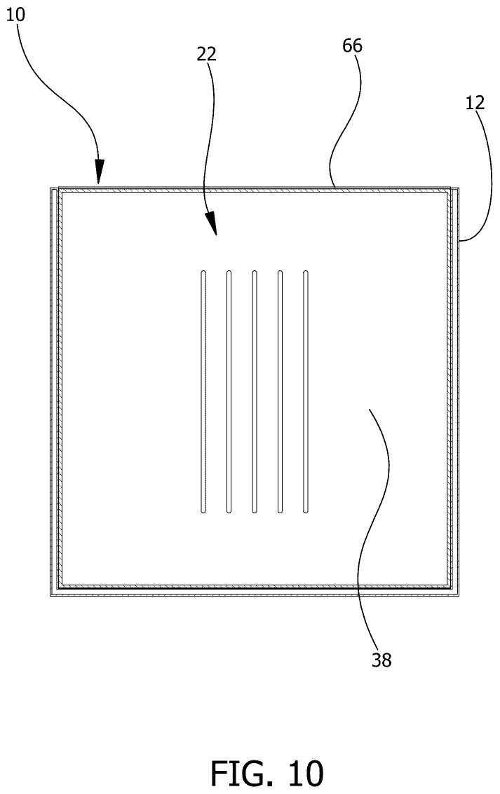

With reference now to the drawings, and in particular to FIGS. 1 through 11 thereof, a new climate-controlled produce container embodying the principles and concepts of an embodiment of the disclosure and generally designated by the reference numeral 10 will be described.

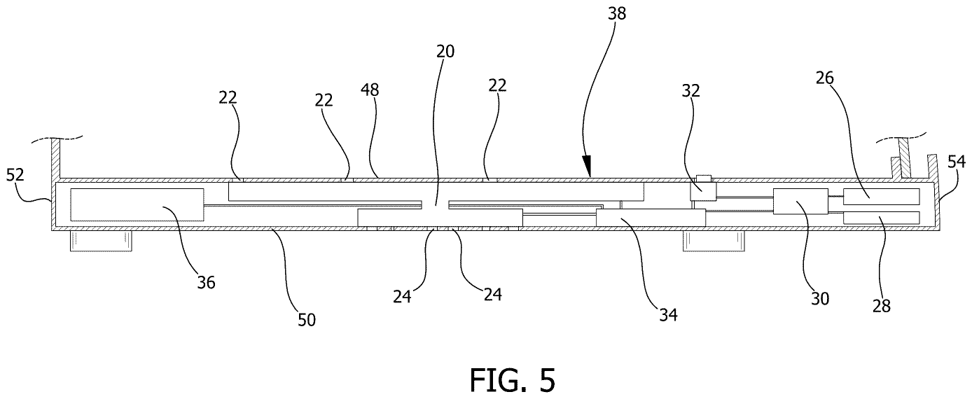

As best illustrated in FIGS. 1 through 11, the climate-controlled produce container 10 generally comprises a housing 12 and a cover 14. The housing 12 defines a storage space 16 and includes an aperture 18 to access the storage space 16. The cover 14 is coupled to the housing 12 over the aperture 18. The cover 14 is selectively movable to open and close the storage space 16. With reference to FIG. 5, a vacuum pump 20 is attached to the housing 12. The housing 12 includes an interior vent 22 and an exterior vent 24 in fluid connection with the vacuum pump 20. The vacuum pump 20 is selectively actuatable to pump gas, such as oxygen, nitrogen, and carbon dioxide, from the storage space 16 through the interior vent 22 and out through the exterior vent 24. A first gas tank 26 is attached to the housing 12. The first gas tank 26 contains compressed nitrogen. A second gas tank 28 is attached to the housing 12. The second gas tank 28 contains compressed carbon dioxide. A flow regulator 30 is attached to the housing 12. The flow regulator 30 is connected to each of the first gas tank 26 and the second gas tank 28 to selectively control flow of nitrogen gas and carbon dioxide gas into the storage space 16. A sensor 32 is attached to the housing 12. The sensor 32 is designed to detect concentration of oxygen, nitrogen, and carbon dioxide in the storage space 16. A microprocessor 34 is attached to the housing 12. The microprocessor 34 is connected to the vacuum pump 20, the flow regulator 30, and the sensor 32. The microprocessor 34 is designed to control operation of the vacuum pump 20, the flow regulator 30, and the sensor 32 to selectively adjust the concentration of oxygen, nitrogen, and carbon dioxide in the storage space 16 to minimize decay of fresh produce in the storage space 16. A power supply 36 is attached to the housing 12. The power supply 36 is connected to the microprocessor 34, the vacuum pump 20, the flow regulator 30, and the sensor 32.

The microprocessor 34 is designed to automatically adjust the concentration of oxygen, nitrogen, and carbon dioxide in the storage space 16 in accordance with a predetermined concentration. For clarity, a control interface is not shown in the figures, but could be any type of known control interface, such as a button panel mounted in the housing 12 or a remote control wirelessly connected to the microprocessor 34. In use, the user chooses a desired setting, or possibly the microprocessor 34 is pre-programmed with one setting. The setting would correspond to a desired concentration of oxygen, nitrogen, and carbon dioxide in the storage space 16, which could be selected to control ripening and decay of fresh produce. In one possible embodiment, the concentration could be customizable to cause different effects, such as increased or decreased ripening, for different types of fresh produce, such as fruits and vegetables. The microprocessor 34 automatically adjusts the concentration by flowing gases in and out using the vacuum pump 20 and flow regulator 30 in accordance with the selected or programmed setting.

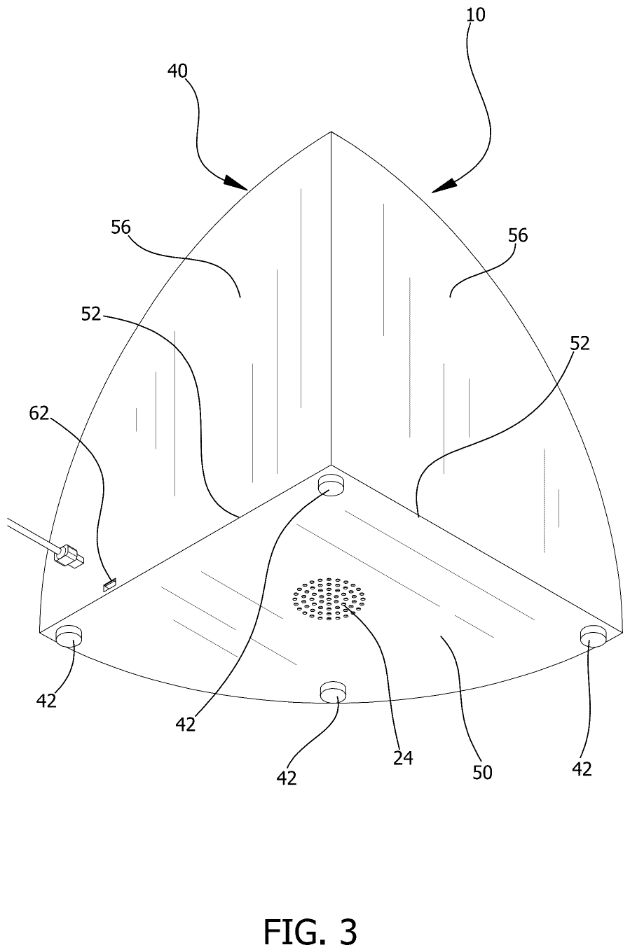

In the exemplary embodiment in FIG. 5, the housing 12 includes a base wall 38 and perimeter walls 40 extending from the base wall 38. Each of the microprocessor 34, the flow regulator 30, the sensor 32, the first gas tank 26, and the second gas tank 28 are positioned in the base wall 38. The sensor 32 is positioned to project out of the base wall 38 into the storage space 16. As shown in FIG. 3, the base wall 38 includes a plurality of spacer feet 42 to produce a gap between the base wall 38 and a support surface for flow of gas out through the exterior vent 24.

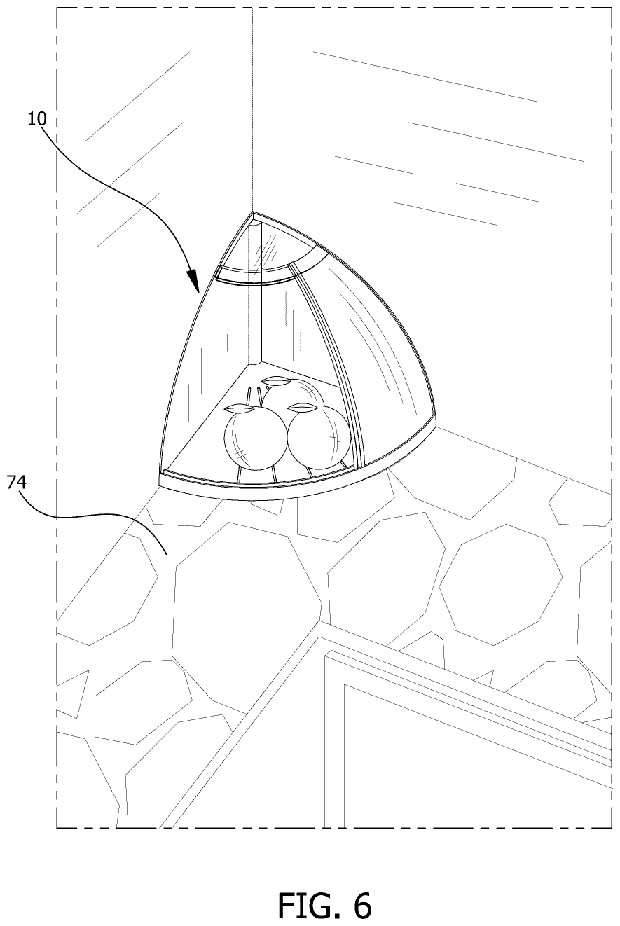

As best seen in FIG. 1, the base wall 38 includes a first guide track 44, and the cover 14 is a plurality of telescoping panels 46 slidably supported in the first guide track 44. Each of the telescoping panels 46 is curved. The base wall 38 is wedge-shaped and includes a top surface 48, a bottom surface 50, and a pair of straight side surfaces 52 arranged respectively at a right angle and oriented perpendicular to the top surface 48 and the bottom surface 50. The base wall 38 also includes a curved side surface 54 connecting the straight sides and oriented perpendicular to the top surface 48 and the bottom surface 50. The first guide track 44 is positioned in the top surface 48 and extends along the curved side surface 54. As best seen in FIG. 3, the perimeter walls 40 include a pair of side walls 56 extending from the straight side surfaces 52 and a top wall 58 connecting the side walls 56. As shown in FIG. 1, the top wall 58 includes a second guide track 60. The telescoping panels 46 are slidably supported in and between the first guide track 44 and the second guide track 60. The power supply 36 includes a rechargeable battery, shown in FIG. 5, positioned in the base wall 38 and, as shown in FIG. 3, a charging port 62 is positioned in the base wall 38 and connected to the rechargeable battery. As shown in FIG. 6, the climate-controlled produce container 10 can be placed on a countertop 74 in a corner area.

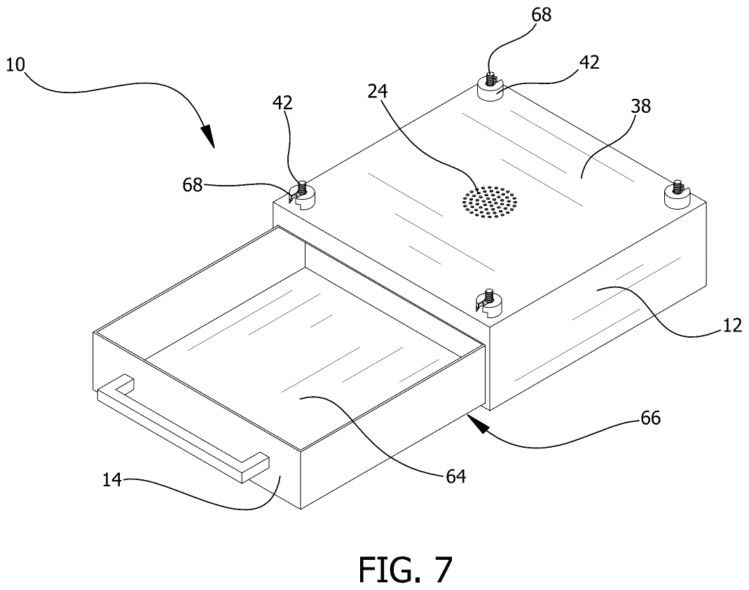

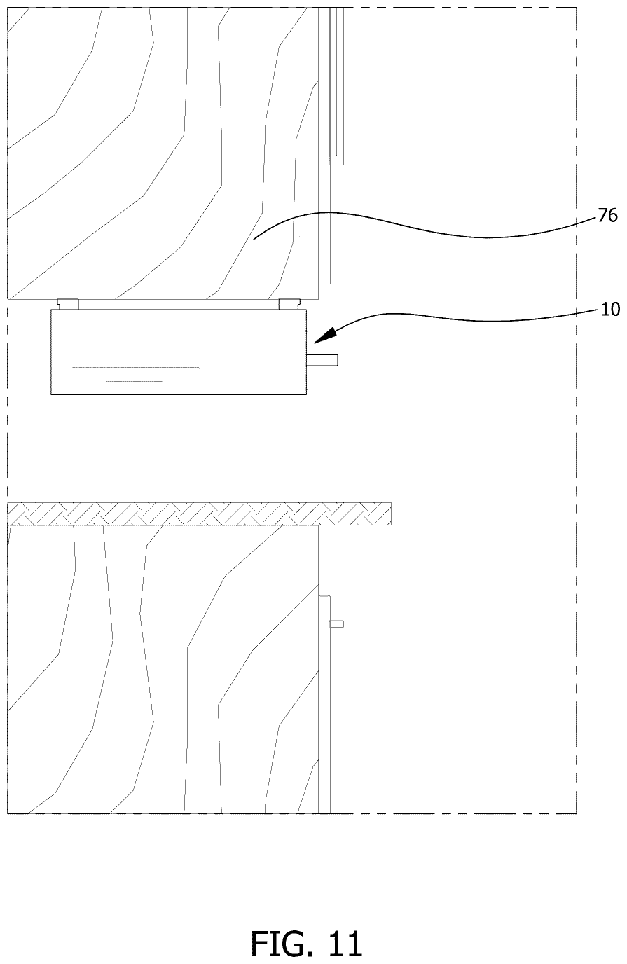

FIGS. 7 through 11 show an alternative embodiment of the climate-controlled produce container 10. In this embodiment, the cover 14 is a single piece and a tray 64 is attached to the cover 14 to form a drawer 66 designed to hold the fresh produce. The drawer 66 is slidable in and out of the housing 12. In this embodiment, the base wall 38 is square, or possibly rectangular, and located above the drawer 66. Instead of being placed on the countertop 74, the spacer feet 42 can include mounting screws 68 for attachment under a surface, such as a cabinet 76, as shown in FIG. 11.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A climate-controlled produce container comprising:
a housing defining a storage space and including an aperture to access said storage space;
a cover being coupled to said housing over said aperture, said cover being selectively movable to open and close said storage space;
a vacuum pump being attached to said housing, said housing including an interior vent and an exterior vent in fluid connection with said vacuum pump, said vacuum pump being selectively actuatable to pump gas from said storage space through said interior vent and out through said exterior vent;
a first gas tank being attached to said housing, said first gas tank containing compressed nitrogen;
a second gas tank being attached to said housing, said second gas tank containing compressed carbon dioxide;
a flow regulator being attached to said housing, said flow regulator being connected to each of said first gas tank and said second gas tank to selectively control flow of nitrogen gas and carbon dioxide gas into said storage space;
a sensor being attached to said housing, said sensor being configured to detect concentration of oxygen, nitrogen, and carbon dioxide in said storage space;
a microprocessor being attached to said housing, said microprocessor being connected to said vacuum pump, said flow regulator, and said sensor, said microprocessor being configured to control operation of said vacuum pump, said flow regulator, and said sensor to selectively adjust the concentration of oxygen, nitrogen, and carbon dioxide in said storage space to minimize decay of fresh produce in said storage space; and
a power supply being attached to said housing, said power supply being connected to said microprocessor, said vacuum pump, said flow regulator, and said sensor.

2. The climate-controlled produce container of claim 1, wherein:
said housing includes a base wall and perimeter walls extending from said base wall;
each of said microprocessor, said flow regulator, said sensor, said first gas tank, and said second gas tank are disposed in said base wall; and
said sensor is disposed to project out of said base wall into said storage space.

3. The climate-controlled produce container of claim 1, wherein said base wall includes a plurality of spacer feet to produce a gap between said base wall and a support surface for flow of gas out through said exterior vent.

4. The climate-controlled produce container of claim 1, wherein said power supply includes a rechargeable battery disposed in said base wall and a charging port disposed in said base wall and connected to said rechargeable battery.

5. The climate-controlled produce container of claim 1, wherein said microprocessor is configured to automatically adjust the concentration of oxygen, nitrogen, and carbon dioxide in said storage space in accordance with a predetermined concentration.

6. The climate-controlled produce container of claim 1, wherein said base wall includes a guide track, and said cover is a plurality of telescoping panels slidably supported in said guide track.

7. The climate-controlled produce container of claim 6, wherein each of said telescoping panels is curved.

8. The climate-controlled produce container of claim 7, wherein:
said base wall is wedge-shaped and includes:
a top surface,
a bottom surface,
a pair of straight side surfaces arranged respectively at a right angle and oriented perpendicular to said top surface and said bottom surface, and
a curved side surface connecting said straight sides and oriented perpendicular to said top surface and said bottom surface; and
said guide track is disposed in said top surface and extends along said curved side surface.

9. The climate-controlled produce container of claim 8, wherein:
said perimeter walls include a pair of side walls extending from said straight side surfaces and a top wall connecting said side walls;
said guide track is a first guide track and said top wall includes a second guide track; and
said telescoping panels are slidably supported in and between said first guide track and said second guide track.

10. The climate-controlled produce container of claim 1, further including a tray being attached to said cover to form a drawer configured to hold the fresh produce, said drawer being slidable in and out of said housing.

11. The climate-controlled produce container of claim 2, wherein said base wall includes a plurality of spacer feet to produce a gap between said base wall and a support surface for flow of gas out through said exterior vent.

12. The climate-controlled produce container of claim 11, wherein said power supply includes a rechargeable battery disposed in said base wall and a charging port disposed in said base wall and connected to said rechargeable battery.

13. The climate-controlled produce container of claim 12, wherein said microprocessor is configured to automatically adjust the concentration of oxygen, nitrogen, and carbon dioxide in said storage space in accordance with a predetermined concentration.

14. The climate-controlled produce container of claim 13, wherein said base wall includes a guide track, and said cover is a plurality of telescoping panels slidably supported in said guide track.

15. The climate-controlled produce container of claim 14, wherein each of said telescoping panels is curved.

16. The climate-controlled produce container of claim 15, wherein:
said base wall is wedge-shaped and includes:
a top surface,
a bottom surface,
a pair of straight side surfaces arranged respectively at a right angle and oriented perpendicular to said top surface and said bottom surface, and
a curved side surface connecting said straight sides and oriented perpendicular to said top surface and said bottom surface; and
said guide track is disposed in said top surface and extends along said curved side surface.

17. The climate-controlled produce container of claim 16, wherein:
said perimeter walls include a pair of side walls extending from said straight side surfaces and a top wall connecting said side walls;
said guide track is a first guide track and said top wall includes a second guide track; and
said telescoping panels are slidably supported in and between said first guide track and said second guide track.

18. The climate-controlled produce container of claim 13, further including a tray being attached to said cover to form a drawer configured to hold the fresh produce, said drawer being slidable in and out of said housing.
